(19) United States
(12) Patent Application Publication
(10) Pub. No.: US 2023/0075976 A1
(43) Pub. Date: Mar. 9, 2023

(54) SYSTEMS AND METHODS FOR ANONYMIZING MEDIA FILES FOR TESTING

(71) Applicant: Meta Platforms, Inc., Menlo Park, CA (US)

(72) Inventors: Maxim Bykov, Redwood City, CA (US); Victor Cherepanov, Sammamish, WA (US)

(21) Appl. No.: 17/469,717

(22) Filed: Sep. 8, 2021

(51) Int. Cl. G11B 27/036; G06F 21/10

(52) U.S. Cl. CPC G11B 27/036; G06F 21/10; G06F 2221/0724

(57) ABSTRACT

A computer-implemented method for anonymizing media files for testing may include (i) identifying a computing process that processes media files, (ii) identifying a media file with at least one characteristic expected to produce output usable for improving the computing process when used as input data to perform a test of the computing process, (iii) anonymizing the media file by replacing content in the media file with predetermined filler content while maintaining the at least one characteristic in a valid state for producing the output usable for improving the computing process, and (iv) initiating the test of the computing process using the anonymized media file as the input data such that the output of the test can be used to improve the computing process. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for anonymizing media files for testing.

FIG. 2 is a flow diagram of an exemplary method for anonymizing media files for testing.

FIG. 3 is an illustration of an exemplary media file before and after anonymization.

FIG. 4 is an illustration of different options for anonymizing a media file.

FIG. 5 is a flow diagram of an exemplary method for anonymizing media files for testing.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The present disclosure is generally directed to systems and methods for anonymizing media content for use in testing internal systems and/or supplying external vendors with relevant test data. A platform (e.g., a social networking platform) may have access to a large amount of user-uploaded media items, such as videos, audio files, and/or images that are subject to various privacy policies and/or regulations that govern how long the content may be stored, how the content may be used, and/or with whom the content may be shared. It may be helpful in many situations to use existing media files to reproduce production errors and/or test new features, but this strategy may run into the aforementioned regulatory and/or privacy issues.

In order to approximate existing media files while preserving privacy, the systems described herein may anonymize the file content. For example, the systems described herein may replace each frame of a video with filler content, such as black frames, a static image, or a pre-generated sequence. In some embodiments, the disclosed system may keep header data (e.g., meta information) intact while anonymizing content and preserving file size, creating a file that can be used to accurately reproduce issues but which does not contain any personal data relevant to user privacy. In some examples, the systems described herein may then use this file to test pipelines and/or processes, share with external vendors and/or partners, and/or perform any other type of debugging and/or testing.

In some embodiments, the systems described herein may improve the functioning of a computing device by facilitating tests that produce information usable to improve processes executing on the computing device. For example, the systems described herein may facilitate identifying and/or fixing bugs in code executing on a computing device. In some embodiments, the systems described herein may improve a computing device by enabling the computing device to store test data that the computing device would otherwise be prevented from storing by privacy policies. Additionally, the systems described herein may improve the fields of social media and/or debugging by improving the quantity and quality of test data available to test and debug processes on social media and other platforms that host user-supplied data.

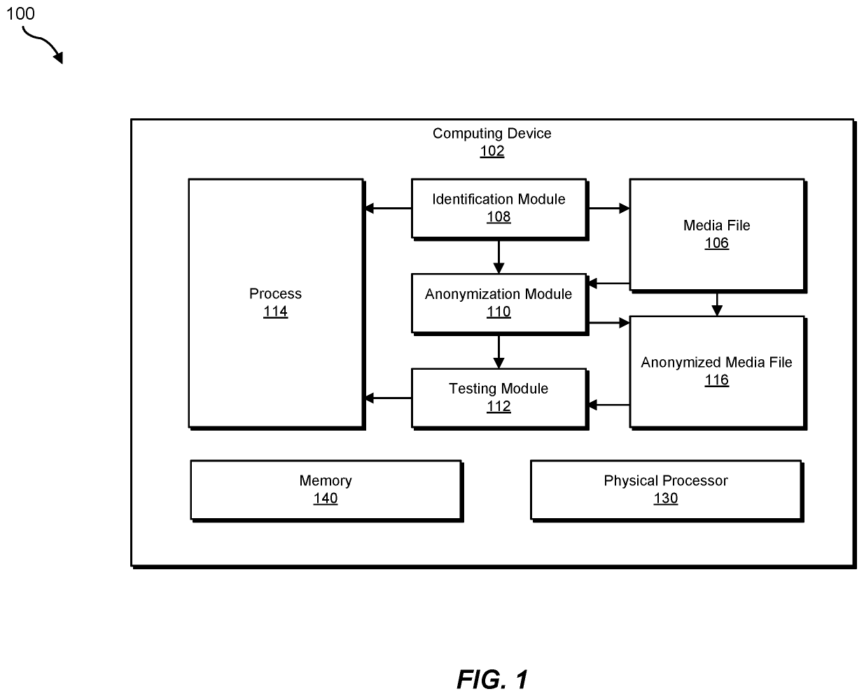

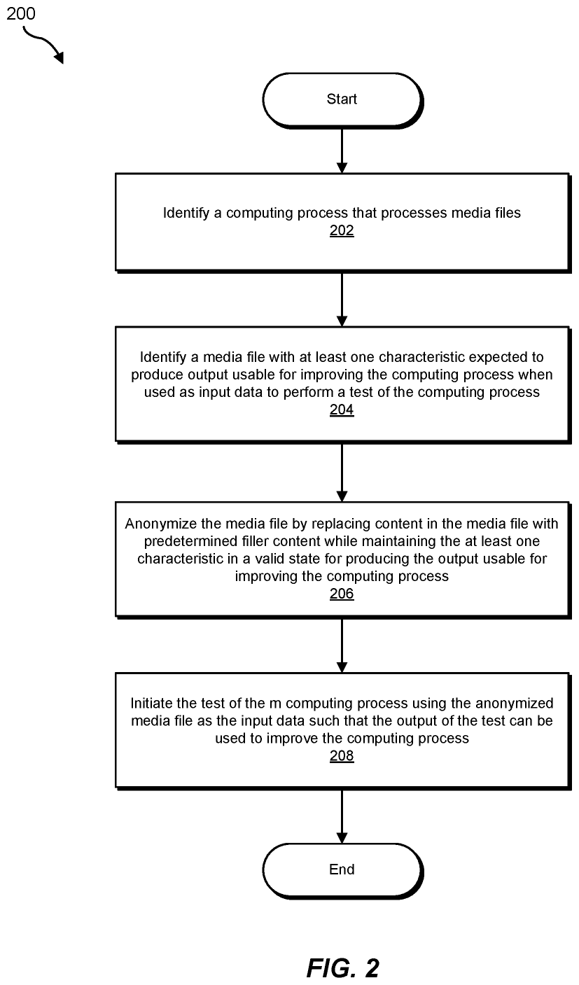

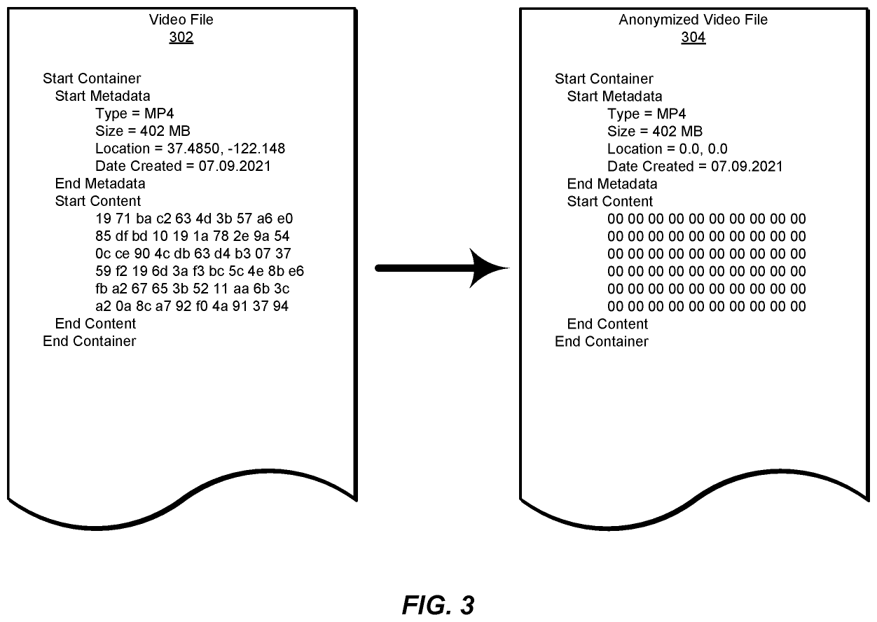

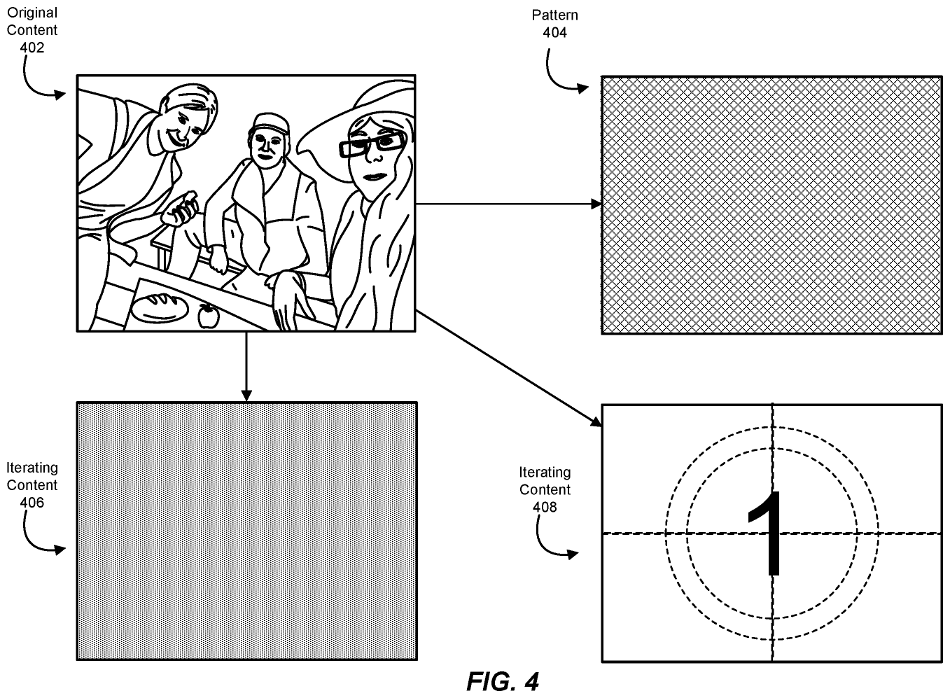

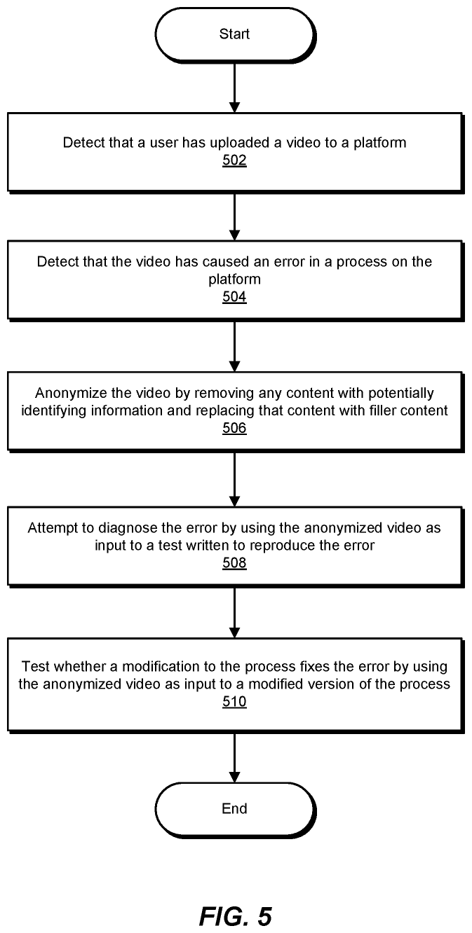

The following will provide detailed descriptions of systems and methods for anonymizing media files with reference to FIGS. 1 and 2, respectively. A detailed description of anonymizing media files by replacing the content and some but not most metadata will be provided in connection with FIG. 3. Detailed description of different options for replacement filler content will be discussed in connection with FIG. 4. A detailed description of one example use-case for anonymizing media files will be provided in connection with FIG. 5.

In some embodiments, the systems described herein may anonymize media files on a computing device, such as a personal computing device or a server. FIG. 1 is a block diagram of an exemplary system 100 for anonymizing media files. In one embodiment, and as will be described in greater detail below, a computing device 102 may be configured with an identification module 108 that may identify a process 114 that processes media files. Identification module 108 may also identify a media file 106 with at least one characteristic expected to produce output usable for improving process 114 when used as input data to perform a test of process 114. In response to these identifications, an anonymization module 110 may anonymize media file 106 by replacing content in media file 106 with predetermined filler content while maintaining the at least one characteristic in a valid state for producing the output usable for improving the process 114. Immediately or at some later time, a testing module 112 may initiate the test of process 114 using the anonymized media file 106 as the input data such that the output of the test can be used to improve the process 114.

Computing device 102 generally represents any type or form of computing device capable of reading computer-executable instructions. For example, computing device 102 may represent a backend computing device such as an application server, database server, and/or any other relevant type of server. Additional examples of computing device 102 may include, without limitation, a laptop, a desktop, a wearable device, a smart device, an artificial reality device, a personal digital assistant (PDA), etc. Although illustrated as a single entity in FIG. 1, computing device 102 may include and/or represent a group of multiple computing devices and/or servers that operate in conjunction with one another.

Media file 106 generally represents any type or form of digital media, including but not limited to video files, audio files, and/or image files. In some embodiments, media file 106 may include content, such as video, audio, and/or images, as well as metadata, such as the location at which the media was captured, a timestamp of when the media file was created, the size of the media file, and/or other information about the media file.

Process 114 generally represents any type or form of computing process that processes media files. In some embodiments, process 114 may process media files by transmitting the media files. For example, process 114 may upload media files to a server, transfer media files between servers, download media files to a computing device, and/or move media files between different locations on the same device (e.g., different folders on a server). In some examples, process 114 may adjust permissions on a media file, for example by adding viewing permissions to a user or group of users with whom the media file has been shared via a post and/or private message on a social networking platform. In one embodiment, process 114 may process media files by displaying the media files. For example, process 114 may play media files in a media player (e.g., a video player) within an application and/or web browser. Additionally or alternatively, process 114 may process media files by modifying the media files. For example, process 114 may compress media files to reduce file size, transcode media files into different file types, resize the display area of media files (e.g., by cropping an image, changing the aspect ratio of a video, etc.), modify the content of media files (e.g., by adding filters to an image or video), and/or perform any other relevant type of modification.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 2 is a flow diagram of an exemplary method 200 for anonymizing media files. In some examples, at step 202, one or more of the systems described herein may identify a computing process that processes media files. For example, identification module 108 may, as part of computing device 102 in FIG. 1, identify process 114 that processes media files.

Identification module 108 may identify the computing process in a variety of ways and/or contexts. For example, identification module 108 may identify a set of automated tests (e.g., unit tests) that test computing processes that process media files. In some examples, identification module 108 may identify the computing process in response to the computing process producing an error (e.g., failing, producing an error code, etc.) either in a production environment or a test environment. In some embodiments, identification module 108 may receive input from a user identifying the computing process.

At step 204, one or more of the systems described herein may identify a media file with at least one characteristic expected to produce output usable for improving the computing process when used as input data to perform a test of the computing process. For example, identification module 108 may, as part of computing device 102 in FIG. 1, identify media file 106 with at least one characteristic expected to produce output usable for improving process 114 when used as input data to perform a test of the computing process.

The term “characteristic” may generally refer to any trait and/or description of a media file. In some examples, a characteristic of a media file may be metadata and/or header data describing the media file, such as the file type or file size. In one example, a characteristic of a media file may be that the media file produced an error when used as input for a computing process. In this example, it may not be initially obvious what specifically about the media file caused the error, but the media file may have the characteristic of being usable to reproduce the error. In some embodiments, a characteristic of a media file may be the container of the media file (e.g., the file type).

The term “output usable for improving the computing process” may generally refer to any results of providing a media file as input to a computing process, including a modified version of the media file that results from the process, errors and/or other debugging data generated by the process, and/or data collected while monitoring the process (e.g., total execution time of the process, computing resources consumed by the process, etc.). In some examples, output usable for improving a computing process may include information that enables a developer to modify the code of a computing process to remove a bug from the computing process and/or improve the efficiency of the computing process.

Identification module 108 may identify the media file in a variety of ways and/or contexts. For example, identification module 108 may identify the media file due detecting an error produced by the computing process after receiving the media file as input. In another example, identification module 108 may identify the media file by performing a search for media files with specified characteristics (e.g., file size, file type, etc.).

At step 206, one or more of the systems described herein may anonymize the media file by replacing content in the media file with predetermined filler content while maintaining the at least one characteristic in a valid state for producing the output usable for improving the computing process. For example, anonymization module 110 may, as part of computing device 102 in FIG. 1, anonymize media file 106 by replacing content in media file 106 with predetermined filler content while maintaining the at least one characteristic in a valid state for producing the output usable for improving process 114.

Anonymization module 110 may anonymize a media file in a variety of ways. For example, anonymization module 110 may replace video, audio, and/or image content in the media file with predetermined filler content while leaving metadata intact. In other examples, anonymization module 110 may replace some metadata. For example, as illustrated in FIG. 3, the systems described herein may identify a video file 302 that includes various metadata as well as video content. In one embodiment, the systems described herein may create anonymized video file 304 by replacing the content of video file 302 with filler content (e.g., completely black frames) and replacing the location metadata, which may be personally identifying information about the user who created video file 302, with a neutral location. In this example, the systems described herein may maintain the file size of video file 302 and/or may avoid changing other metadata, such as date created.

By changing only the content of the file and select metadata, the systems described herein may maintain the characteristic of the file in a valid state for producing output usable for improving a computing process. For example, if the characteristic is the file size, the systems described herein may replace the content such that the file size remains unchanged or only changes slightly (e.g., by fewer than ten bytes, fewer than 100 bytes, etc.). In another example, the systems described herein may maintain the filetype of the file.

Anonymization module 110 may replace the content of the media file with various types of predetermined filler content. In some embodiments, anonymization module 110 may replace content in the media file with randomized content (e.g., visual and/or audio static). In other examples, anonymization module 110 may replace content with non-random content. For example, as illustrated in FIG. 4, anonymization module 110 may replace content 402 with a pattern 404. In one example, pattern 404 may be a repeating monochrome pattern (e.g., a grey repeated beat pattern). In some examples, anonymization module 110 may replace content 402 with iterative content that may be useful for testing purposes (e.g., to identify whether frames have been dropped). In one example, anonymization module 110 may replace content 402 with iterating content 406, a sequence of colors (e.g., red, orange, yellow, green, blue, purple, red). In another example, anonymization module 110 may replace content 402 with iterating content 408, a sequence of numbers (e.g., starting at “1” and incrementing by one per frame).

In some examples, anonymization module 110 may replace all content within a media file, leaving none of the original content. By replacing all of the content, anonymization module 110 may ensure that no personally identifying information from the content (e.g., images, video, and/or audio of users) remains in the anonymized media file. In one embodiment, anonymization module 110 may replace content within a media file by finding the byte position at which the content starts and replacing all subsequent bytes with bytes representing the predetermined filler content. In one embodiment, anonymization module 110 may insert filler content for I frames and may encode “skip all data” for B and/or P frames, enabling the codec to fill in the remaining data for that group of pictures (GOP). Alternatively, anonymization module 110 may replace some but not all content. For example, anonymization module 110 may leave a few pixels (e.g., two pixels, five pixels, etc.) from the original content at one corner and/or edge of each frame but may replace all other pixels in each frame, protecting user privacy while preserving some of the original content for testing purposes. In another embodiment, anonymization module 110 may preserve a few milliseconds of audio every second while replacing all other audio.

Returning to FIG. 2, at step 208, one or more of the systems described herein may initiate a test of the computing process using the anonymized media file as the input data such that the output of the test can be used to improve the computing process. For example, testing module 112 may, as part of computing device 102 in FIG. 1, initiate a test of process 114 using the anonymized media file 106 as the input data such that the output of the test can be used to improve process 114.

Testing module 112 may initiate the test in a variety of ways. In some embodiments, the test may be an automatic test (e.g., a unit test) that may run using the media file as input on a scheduled basis and/or in response to certain triggers (e.g., new code being committed). Additionally or alternatively, testing module 112 may initiate the test by alerting a developer that the anonymized media file is ready to be used as input. In some embodiments, testing module 112 may initiate a test by transmitting the anonymized file to a third party that does not have access to the media file. For example, testing module 112 may send and/or upload the anonymized media file to an open-source platform.

In some embodiments, the systems described herein may anonymize a media file in response to detecting that the media file has caused an error. For example, as illustrated in FIG. 5, at step 502, the systems described herein may detect that a user has uploaded a video to a platform. For example, the systems described herein may detect that a user has uploaded a video of a party to a social media platform. At step 504, the systems described herein may detect that the video has caused an error in a process on the platform. For example, the systems described herein may detect that the user attempted to share the video with other users of the social media platform and the other users were unable to play the video in the social media platform's video player. At step 506, the systems described herein may anonymize the video by removing any content with potentially identifying information and replacing that content with filler content. For example, the systems described herein may replace video of the party with an iterating pattern of numbers and audio of the party with audio static.

In some examples, at step 508, the systems described herein may attempt to diagnose the error by using the anonymized video as input to a test written to reproduce the error. For example, the systems described herein may provide the video as input to a test that replicates the process of a user who is not the creator of a video playing the video in the social media platform's video player. In one example, debug data from this test may indicate that the file size of the video causes an error in a line of code related to executing the video player. In this example, a developer may use this data to modify the line of code to accommodate a larger range of file sizes. In some examples, at step 510, the systems described herein may test whether a modification to the process fixes the error by using the anonymized video as input to a modified version of the process. For example, the systems described herein may rerun the test using the modified code to determine whether the video still causes the error.

As described above, the systems and methods described herein may anonymize media files for use as test data to improve various computing processes that transmit, display, modify, or otherwise process media files. By anonymizing existing media files, the systems described herein may avoid numerous regulatory and privacy issues associated with handling, storing, and/or transmitting files containing personally identifying information or other sensitive information. Anonymizing existing files may have significant efficiency gains over creating new test data from scratch and may additionally improve testing by enabling developers to use a version of the specific file that triggered an error to test bug fixes for the error, rather than attempting to create new test data that might reproduce the error. By removing private information from files, the systems described herein may enable platforms to contribute the anonymized files to open-source efforts and/or share the anonymized files with third-party partners, improving the ability of platforms to collaborate and contribute to open-source efforts without reducing user privacy.

### EXAMPLE EMBODIMENTS

Example 1: A method for anonymizing media files may include (i) identifying a computing process that processes media files, (ii) identifying a media file with at least one characteristic expected to produce output usable for improving the computing process when used as input data to perform a test of the computing process, (iii) anonymizing the media file by replacing content in the media file with predetermined filler content while maintaining the at least one characteristic in a valid state for producing the output usable for improving the computing process, and (iv) initiating the test of the computing process using the anonymized media file as the input data such that the output of the test can be used to improve the computing process.

Example 2: The computer-implemented method of example 1, where the media file may include video and anonymizing the media file may include replacing video content with predetermined video content.

Example 3: The computer-implemented method of examples 1-2, where the media file may include audio and anonymizing the media file may include replacing audio content with predetermined audio content.

Example 4: The computer-implemented method of examples 1-3, where anonymizing the media file may include replacing at least one piece of metadata that includes potentially identifying information.

Example 5: The computer-implemented method of examples 1-4, where the media file may include a user-uploaded file that includes potentially identifying information about a user and anonymizing the media file may include replacing the potentially identifying information about the user with non-identifying content.

Example 6: The computer-implemented method of examples 1-5, where identifying the media file with the at least one characteristic expected to produce the output usable for improving the computing process may include detecting an error produced by providing the media file as input to the computing process.

Example 7: The computer-implemented method of examples 1-6, where replacing the content in the media file with the predetermined filler content may include replacing all the content in the media file with the predetermined filler content.

Example 8: The computer-implemented method of examples 1-7, where replacing the content in the media file with the predetermined filler content may include replacing the content with randomized content.

Example 9: The computer-implemented method of examples 1-8, where replacing the content in the media file with the predetermined filler content may include replacing video content in the file with pre-generated iterative content.

Example 10: The computer-implemented method of examples 1-9, where the iterative content may include a sequence of numbers.

Example 11: The computer-implemented method of examples 1-10, where the iterative content may include a sequence of colors.

Example 12: The computer-implemented method of examples 1-11, where replacing the content in the media file with the predetermined filler content may include replacing video content in the file with a repeating monochrome pattern.

Example 13: The computer-implemented method of examples 1-12, where replacing the content in the media file may include: determining a byte position within the media file at which the content starts and replacing bytes after the byte position with bytes representing the predetermined filler content.

Example 14: The computer-implemented method of examples 1-13, where at least one characteristic may include a container of the media file.

Example 15: The computer-implemented method of examples 1-14, where at least one characteristic may include (i) a file type of the media file, (ii) header data of the media file, (iii) metadata of the media file or, and/or (iv) a file size of the media file.

Example 16: The computer-implemented method of examples 1-15, where initiating the test of the computing process may include transmitting the anonymized file to a third party that does not have access to the media file.

Example 17: The computer-implemented method of examples 1-16, where the computing process processes the media files by transmitting the media files.

Example 18: The computer-implemented method of examples 1-17, where the computing process processes the media files by displaying the media files.

Example 19: A system for anonymizing media files may include at least one physical processor and physical memory including computer-executable instructions that, when executed by the physical processor, cause the physical processor to (i) identify a computing process that processes media files, (ii) identify a media file with at least one characteristic expected to produce output usable for improving the computing process when used as input data to perform a test of the computing process, (iii) anonymize the media file by replacing content in the media file with predetermined filler content while maintaining the at least one characteristic in a valid state for producing the output usable for improving the computing process, and (iv) initiate the test of the computing process using the anonymized media file as the input data such that the output of the test can be used to improve the computing process.

Example 20: A non-transitory computer-readable medium may include one or more computer-readable instructions that, when executed by at least one processor of a computing device, cause the computing device to (i) identify a computing process that processes media files, (ii) identify a media file with at least one characteristic expected to produce output usable for improving the computing process when used as input data to perform a test of the computing process, (iii) anonymize the media file by replacing content in the media file with predetermined filler content while maintaining the at least one characteristic in a valid state for producing the output usable for improving the computing process, and (iv) initiate the test of the computing process using the anonymized media file as the input data such that the output of the test can be used to improve the computing process.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
detecting an error caused by providing a media file as a input to a computing pocess;
identifying, in response to detecting the error, at least one characteristic of the media file expected to produce output usable for improving the computing process when the media file is used as input data to perform a test of the computing process;
creating an anonymized version of the media file by replacing content in the media file with predetermined filler content while maintaining the at least one characteristic in a valid state for producing the output usable for improving the computing process; and
initiating the test of the computing process using the anonymized version of the media file as the input data such that the output of the test can be used to improve the computing process.

2. The computer-implemented method of claim 1, wherein:
the media file comprises video; and
anonymizing the media file comprises replacing video content with predetermined video content.

3. The computer-implemented method of claim 1, wherein:
the media file comprises audio; and
anonymizing the media file comprises replacing audio content with predetermined audio content.

4. The computer-implemented method of claim 1, wherein anonymizing the media file comprises replacing at least one piece of metadata that comprises potentially identifying information.

5. The computer-implemented method of claim 1, wherein:
the media file comprises a user-uploaded file that comprises potentially identifying information about a user; and
anonymizing the media file comprises replacing the potentially identifying information about the user with non-identifying content.

6. The computer-implemented method of claim 1, wherein detecting the error comprises detecting the error in an end-user facing production environment.

7. The computer-implemented method of claim 1, wherein replacing the content in the media file with the predetermined filler content comprises replacing all the content in the media file with the predetermined filler content.

8. The computer-implemented method of claim 1, wherein replacing the content in the media file with the predetermined filler content comprises replacing the content with randomized content.

9. The computer-implemented method of claim 1, wherein replacing the content in the media file with the predetermined filler content comprises replacing video content in the media file with pre-generated iterative content.

10. The computer-implemented method of claim 9, wherein the pre-generated iterative content comprises a sequence of numbers.

11. The computer-implemented method of claim 9, wherein the pre-generated iterative content comprises a sequence of colors.

12. The computer-implemented method of claim 1, wherein replacing the content in the media file with the predetermined filler content comprises replacing video content in the file with a repeating monochrome pattern.

13. The computer-implemented method of claim 1, wherein replacing the content in the media file comprises:
determining a byte position within the media file at which the content starts; and
replacing bytes after the byte position with bytes representing the predetermined filler content.

14. The computer-implemented method of claim 1, wherein the at least one characteristic comprises a container of the media file.

15. The computer-implemented method of claim 1, wherein the at least one characteristic comprises at least one of:
a file type of the media file;
header data of the media file;
metadata of the media file; or
a file size of the media file.

16. The computer-implemented method of claim 1, wherein initiating the test of the computing process comprises transmitting the anonymized version of the file to a third party that does not have access to the media file.

17. The computer-implemented method of claim 1, wherein the computing process processes the media files by transmitting the media files.

18. The computer-implemented method of claim 1, wherein the computing process processes the media files by displaying the media files.

19. A system comprising:
at least one physical processor;
physical memory comprising computer-executable instructions that, when executed by the physical processor, cause the physical processor to:
detect an error caused by providing a media file as an input to a computing process;
identify, in response to detecting the error, at least one characteristic of the media file expected to produce output usable for improving the computing process when the media the media file is used as input data to perform a test of the computing process;
create an anonymized version of the media file by replacing content in the media file with predetermined filler content while maintaining the at least one characteristic in a valid state for producing the output usable for improving the computing process; and
initiate the test of the computing process using the anonymized version of the media file as the input data such that the output of the test can be used to improve the computing process.

20. A non-transitory computer-readable medium comprising one or more computer-readable instructions that, when executed by at least one processor of a computing device, cause the computing device to:
detect an error caused by providing a media file as an input to a computing process;
identify, in response to detecting the error, at least one characteristic of the media file expected to produce output usable for improving the computing process when the media file is used as input data to perform a test of the computing process;
create an anonymized version of the media file by replacing content in the media file with predetermined filler content while maintaining the at least one characteristic in a valid state for producing the output usable for improving the computing process; and
initiate the test of the computing process using the anonymized version of the media file as the input data such that the output of the test can be used to improve the computing process.
